(19) United States
(12) Patent Application Publication
(10) Pub. No.: US 2006/0210243 A1
(43) Pub. Date: Sep. 21, 2006

(54) Information recording medium and apparatus for recording information to or reproducing information from the same

(75) Inventor: Hyun-soo Park, Seoul (KR)

Correspondence Address: STEIN, MCEWEN & BUI, LLP, 1400 EYE STREET, NW, SUITE 300, WASHINGTON, DC, 20005, US

(73) Assignee: Samsung Electronics Co., Ltd., Suwon-si (KR)

(21) Appl. No.: 11/363,959

(22) Filed: Mar. 1, 2006

(30) Foreign Application Priority Data
Mar. 17, 2005 (KR) 2005-22192

(51) Int. Cl. H04N 7/087

(52) U.S. Cl. 386/84

(57) ABSTRACT

An information recording medium including a sync signal with improved detectability to reliably reproduce data recorded on the information recording medium. The sync signal includes a pattern having at least one interval greater than or equal to a maximum available pit or space length by which reproducible data are recorded on the recording medium and at least one other interval having a length equal to or greater than a predetermined length which causes no signal distortion in a reproduction signal, wherein adjacent intervals are inverted with respect to each other. Accordingly, the sync signal can be stably detected by preventing generation of an error upon detection of the sync signal. In particular, the sync signal can be stably detected from a high-density information recording medium, such as, a super-resolution information recording medium. Thus, error correction or data demodulation can be stabilized.

### CROSS-REFERENCE TO RELATED APPLICATIONS

This application claims the benefit of Korean Patent Application No. 2005-22192, filed Mar. 17, 2005, in the Korean Intellectual Property Office, the disclosure of which is incorporated herein by reference.

### BACKGROUND OF THE INVENTION

1. Field of the Invention

Aspects of the present invention relate to an information recording medium, and more particularly, to an information recording medium including a sync signal with improved detectability, to reliably reproduce data. The sync signal according to aspects of the present invention is applicable to an information recording medium to which predetermined data is recorded in a form of marks or pits whose sizes are equal to or less than a resolution limit to improve the recording density (hereinafter, referred to as a super-resolution recording medium).

2. Description of the Related Art

Generally, light reflected from an optical disc is converted into an electrical signal, and the electrical signal undergoes a predetermined signal-processing operation so that binary data recorded on the optical disc are reproduced. The electrical signal is called a radio frequency (RF) signal. Although a binary signal is recorded on the optical disc, the RF signal obtained from the optical disc has characteristics of an analog signal due to properties of the optical disc and optical properties of a reproduction system. The RF signal is binarized to obtain a binary signal.

In a process of extracting an original signal from the binary signal, the binary signal undergoes an operation of correcting an error generated due to scars or dust on the surface of the optical disc, a descrambling operation, a deinterleaving operation, etc. To perform these operations, parity, address information, etc., for error correction are added to a data signal to be recorded on the optical disc, and a final signal to be recorded on the optical disc is obtained through a modulation of the data signal including the parity, address information, etc. During the modulation, a sync signal is inserted into the data signal at regular intervals. Upon reproduction of data from the optical disc, the sync signal is detected and used as a reference signal that informs the start of data demodulation.

In general, the sync signal has a longer period than the data signal. The insertion of the sync signal with a long period contributes to accurately distinguishing the sync signal from the data signal. Thus, the sync signal is used as a reference signal that informs the start of demodulation.

To be more specific, the optical disc stores channel data having bits of 0 or 1 in the form of pits that change a reflectibility or a refractive index of a light beam. Also, a sync signal having a specific pattern is inserted into the channel data at regular intervals. Thus, the channel data is reproduced based on the sync signal that informs the start of the data to be reproduced. For example, as for compact discs (CDs), a 11T/11T sync signal, namely, “1111111111100000000000” or “0000000000011111111111,” is inserted at an interval of 588 channel data. As for digital versatile discs (DVDs), a 14T/4T sync signal, namely, “111111111111110000” or “000000000000001111,” is inserted at an interval of 1488 channel data. Hence, an optical disc system processes data in units of 588 channel data or 1488 channel data based on sync signals attached to both ends of the channel data.

Meanwhile, a demand for large-capacity recording media recently increases. To increase the recording density of an optical disc, a method of reducing a track pitch or a method of reducing the shortest length of a recording pit has been proposed. For example, there is proposed a super-resolution information recording medium from which a recording mark having a smaller size than a reproduction resolution limit, that is, λ/4NA (where a wavelength of a light beam to reproduce data recorded on a recording medium λ and a numerical aperture of an objective lens is NA) is reproduced.

In the super-resolution information recording medium, a temperature distribution or an optical property changes due to a difference between light intensities within an optical spot formed on a super-resolution layer. Thus, marks having sizes smaller than the reproduction resolution limit can be reproduced.

FIG. 1A illustrates a mark pattern which is recorded on a super-resolution information recording medium. FIG. 1B illustrates an RF signal obtained by reproducing the mark pattern of FIG. 1A. When the wavelength of a laser beam is 405 nm, the NA of an objective lens is 0.85, and the resolution limit is about 119 nm, the mark pattern of FIG. 1A is a combination of 2T marks (Φ) with lengths of 75 nm, which is smaller than the resolution limit, 8T marks (O) with lengths of 300 nm, which is greater than the resolution limit, and spaces. Referring to the RF signal of FIG. 1B, when an 8T-long mark or space is around an optical spot, a 2T-long mark is not accurately detected due to an influence of the 8T mark or space.

As described above, such a super-resolution information recording medium has a problem in that inter-symbol interference (ISI) where a current signal is affected by adjacent symbols increases. In particular, when short pits (marks or spaces in recordable discs) are adjacent to long pits, the RF signal is distorted by failing to reach a zero point. In other words, a signal having a short period adjacent to a signal having a long period is not properly detected due to the signal having the long period.

If such a distortion occurs in a sync signal, the sync signal is not properly detected, and thus a problem may occur upon recording and/or reproduction of data after the sync signal.

### SUMMARY OF THE INVENTION

Aspects of the present invention provide an information recording medium including a sync signal which is more reliably detectable, and an apparatus for recording the sync signal and data signals to the optical recording medium or reproducing data from the information recording medium having the sync signal.

According to an aspect of the present invention, an information recording medium includes a sync signal used upon recording/reproduction of data, wherein the sync signal includes a pattern comprising a first interval having a length equal to or longer than a predetermined length which causes no signal distortion in a reproduction signal and a second interval having a length equal to or greater than a maximum available pit or space length by which reproducible data are recorded on the recording medium, wherein the first interval is adjacent to the second interval and the second interval is inverted with respect to the first interval.

The information recording medium may be a super-resolution information recording medium capable of reproducing pits, marks, or spaces that are smaller than or equal to a beam resolution limit.

Each of the intervals may indicate a pit, a mark, or a space that is formed in a predetermined area of the information recording medium.

The sync signal may be formed having three intervals using a pit, a mark, or a space, and where lengths of the three intervals are T₁, T₂, and T₃, the interval lengths satisfy a condition where T₁≧n₁T, T₂≧nₘₐₓT, and T₃≧n₂T, where T denotes a period of a reference clock, n₁T and n₂T denote the pit or space lengths which cause no signal distortion, and nₘₐₓT denotes the maximum available pit or space length.

The sync signal may be formed to have four intervals using a pit, a mark, or a space, and where the lengths of the four intervals are T₁, T₂, T₃, and T₄, the intervals lengths satisfy a condition where T₁≧n₁T, T₂=T₃=nₘₐₓT, and T₄≧n₂T, where T denotes a period of a reference clock, n₁T and n₂T denote lengths which cause no signal distortion, and nₘₐₓT denotes the maximum available pit or space length.

The sync signal may be formed to have five intervals using a pit, a mark, or a space, and where the lengths of the four intervals are T₁, T₂, T₃, T₄, and T₅, the intervals satisfy a condition where T₁≧n₁T, T₂=T₃=T₄=nₘₐₓT, and T₅≧n₂T, where T denotes a period of a reference clock, n₁T and n₂T denotes lengths which cause no signal distortion, and nₘₐₓT denotes the maximum available pit or space length.

The sync signal may be formed to have six intervals using a pit, a mark, or a space, and where lengths of the six intervals are T₁, T₂, T₃, T₄, T₅, and T₆, the intervals satisfy a condition where T₁≧n₁T, T₂=T₃=T₄=T₅=nₘₐₓT, and T₆≧n₂T where T denotes a period of a reference clock, n₁T and n₂T denote lengths which cause no signal distortion, and nₘₐₓT denotes the maximum available pit or space length.

The n₁ and n₂ may be 4, and the nₘₐₓ may be 9.

According to another aspect of the present invention, an apparatus for reproducing data from an information recording medium includes a signal detection unit detecting a signal recorded on the information recording medium, a binarization unit converting an analog signal obtained by the signal detection unit into a digital signal, a sync signal detection unit extracting a sync signal from the digital signal output from the binarization unit, a data synchronization unit producing a reference signal for data reproduction from the sync signal, and a data reproduction unit reproducing data recorded on the information recording medium using the digital signal output by the binarization unit and the reference signal output by the data synchronization unit. The sync signal includes a pattern comprising a first interval having a length greater than or equal to a maximum available pit or space length by which reproducible data are recorded on the recording medium and a second interval having a length equal to or greater than a predetermined length which causes no signal distortion in a reproduction signal, wherein the second interval is adjacent to the first interval and the second interval is inverted with respect to the first interval.

According to another aspect of the present invention, an apparatus for recording data to an information recording medium includes a recording unit recording data on the information recording medium in units of a predetermined recording block, and a control unit controlling the recording unit to record a sync signal in every recording block. The sync signal includes a pattern comprising a first interval having a length greater than or equal to a maximum available pit or space length by which reproducible data are recorded on the recording medium and a second interval having a length equal to or greater than a predetermined length which causes no signal distortion in a reproduction signal, wherein the second interval is adjacent to the first interval and the second interval is inverted with respect to the first interval.

Additional aspects and/or advantages of the invention will be set forth in part in the description which follows and, in part, will be obvious from the description, or may be learned by practice of the invention.

### BRIEF DESCRIPTION OF THE DRAWINGS

These and/or other aspects and/or advantages of the invention will become apparent and more readily appreciated from the following description of the embodiments, taken in conjunction with the accompanying drawings of which:

FIG. 1 illustrates a writing pattern of marks recorded on a conventional super-resolution recording medium and a radio frequency (RF) signal obtained by reproducing the mark pattern;

FIGS. 2A and 2B are graphs of an amplitude of an RF signal according to a variation in pit lengths recorded on an information recording medium;

FIG. 3A illustrates a sync signal included in an information recording medium, according to an embodiment of the present invention;

FIG. 3B illustrates a bit pattern of the sync signal shown in FIG. 3A;

FIGS. 4 through 6 illustrate sync signals according to other embodiments of the present invention;

FIG. 7 is a block diagram of an apparatus for reproducing an information recording medium including one of the sync signals illustrated in FIGS. 3 through 6, according to an embodiment of the present invention; and

FIG. 8 is a block diagram of an apparatus for recording data to the information recording medium including one of the sync signals illustrated in FIGS. 3 through 6, according to an embodiment of the present invention.

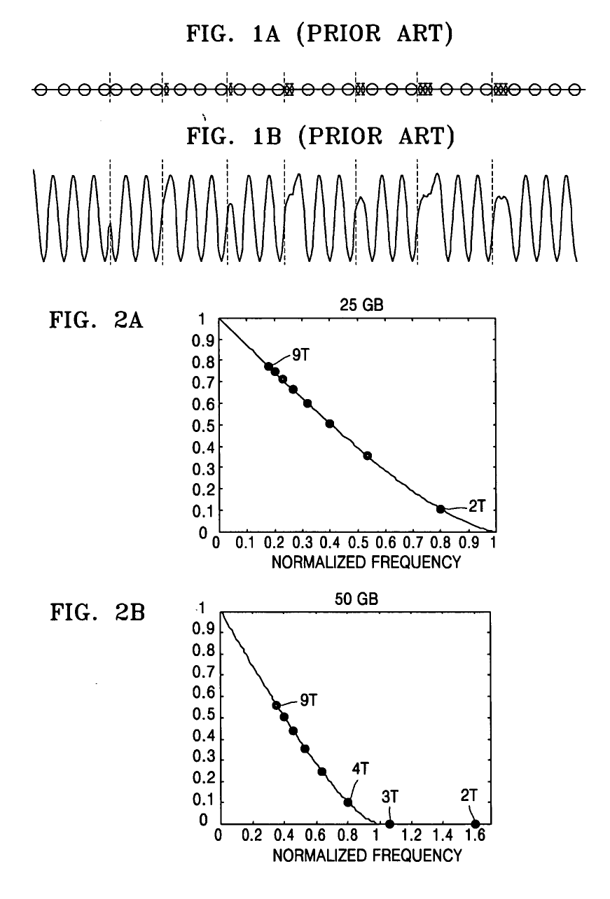

### DETAILED DESCRIPTION OF THE EMBODIMENTS

Reference will now be made in detail to the present embodiments of the present invention, examples of which are illustrated in the accompanying drawings, wherein like reference numerals refer to the like elements throughout. The embodiments are described below in order to explain the present invention by referring to the figures.

FIGS. 2A and 2B are graphs of an amplitude of an RF signal according to a variation in pit lengths recorded on an information recording medium. Where T indicates a period of a reference clock, FIG. 2A shows an amplitude of the RF signal according to pits of which lengths vary from 2T to 9T and which are recorded on an information recording medium having a recording capacity of 25 GB. FIG. 2B shows an amplitude of the RF signal according to pits of which lengths vary from 2T to 9T and which are recorded on an information recording medium having a recording capacity of 50 GB. Here, the amplitudes of the RF signals were measured using a laser beam having a wavelength of 405 nm and an objective lens having a numerical aperture (NA) of 0.85.

Referring to FIG. 2A, in the case of an information recording medium having the relatively small recording capacity of 25 GB, an RF signal whose amplitude is greater than a reference level, that is, 0 in the y-axis, is detected from a 2T-long pit, which is the shortest pit. However, in the case of an information recording medium having a relatively large recording capacity of 50 GB shown in FIG. 2B, RF signals having amplitudes greater than the reference level are detected from pits having lengths of 4T or greater, but RF signals with respect to pits having small lengths of 3T and 2T are detected with amplitudes equal to or smaller than the reference level. As described above, as the recording density of an information recording medium increases, it becomes more difficult to properly reproduce pits having small lengths. Accordingly, where a sync signal is comprised of pits having small lengths, the probability of an error due to non-detection of the sync signal or misdetection of a data signal as the sync signal increases.

According to an aspect of the present invention, a sync signal is comprised of intervals that have lengths equal to or greater than a predetermined length that generates no signal distortion, to properly detect the sync signal which is recorded to serve as a reference signal upon reproduction from the recording medium. Thus, data can be reliably recorded and/or reproduced from an information recording medium having increased recording density, particularly, a super-resolution information recording medium from which small recording pits or marks having lengths less than or equal to a beam resolution limit can be reproduced.

Generally, sync signals recorded on an information recording medium should have uniform lengths, and each of the sync signals has a different pattern from a pattern of a data signal to prevent confusion of the sync signal with the data signal.

In addition to the above general condition, the sync signal according to an embodiment of the present invention includes a first interval with a pit or space (mark or space in recordable discs) having a length equal to or greater than a maximum available pit or space length by which reproducible data are recorded on the recording medium and a second interval with a pit or space equal to or longer than a predetermined length that causes no signal distortion in a reproduction signal, the first interval adjacent to the second interval and inverted from the first interval. That is, if the first interval is the pit, the second interval will be the space and if the first interval is the space, the second interval will be the pit

The sync signal is recorded together with data in a predetermined recording area of an information recording medium and used as a reference signal upon reproduction of the data.

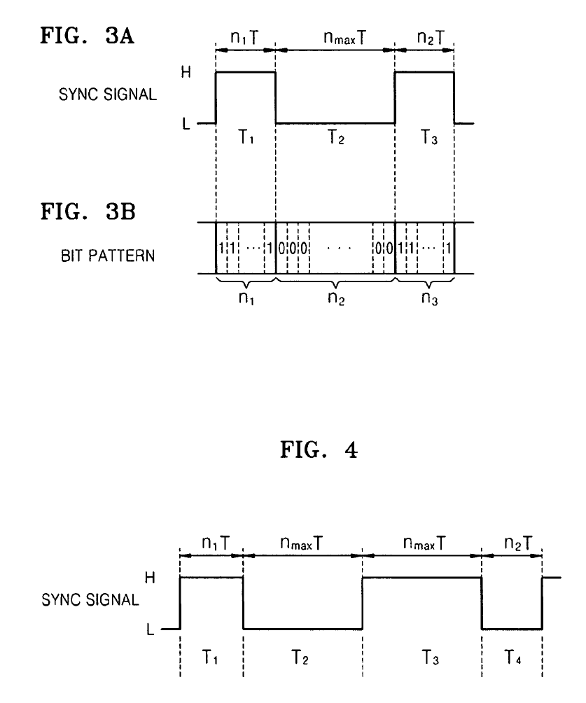

FIG. 3A illustrates a sync signal included in an information recording medium, according to a first embodiment of the present invention and FIG. 3B illustrates a bit pattern of the sync signal shown in FIG. 3A. Referring to FIG. 3A, the sync signal is formed as inversion intervals having a pattern of n₁T, nₘₐₓT, n₂T. Here, nₘₐₓT denotes the maximum length of a pit, mark, or space that is available in an information recording media on which the sync signal is recorded, and n₁T and n₂T denote lengths of pits, marks, or spaces which can be detected without signal distortion upon reproduction of data from the information recording media. For example, for a high-capacity information recording medium as shown in FIG. 2B, an RF signal having an amplitude greater than a reference level is detected from a recording mark or pit having a 4T length, but an RF signal having an amplitude less than or equal to the reference level is detected from a recording mark or pit having a length of less than 4T. Hence, in the embodiment shown in FIG. 3, n₁ and n₂ should be at least 4. In other words, n₁T≧4T, and n₂T≧4T. However, n₁T and n₂T should be less than the maximum length of an available pit or mark.

For example, nₘₐₓT, which is the maximum length of an available pit, mark, or space, may be 9T which is used as a maximum inversion interval of a sync signal in a conventional Blu-ray disc.

Accordingly, the sync signal of FIG. 3A may include inversion intervals T₁, T₂, and T₃ that satisfy T₁≧4T, T₂≧9T, and T₃≧4T. FIG. 3B illustrates a bit pattern obtained from the sync signal pattern of FIG. 3A.

Although FIG. 3A illustrates a sync signal having only one maximum inversion interval, two or more consecutive maximum inversion intervals may be included in the sync signal. Examples of sync signals having two or more consecutive maximum inversion intervals are illustrated in FIGS. 4 through 6 as other embodiments of the present invention.

Referring to FIG. 4, a sync signal according to another embodiment of the present invention is formed with intervals forming a pattern of n₁T, nₘₐₓT, nₘₐₓT, n₂T. In other words, two pits, marks, or spaces of the maximum length are consecutively connected to each other, and pits, marks, or spaces having lengths of n₁T and n₂T greater than or equal to a predetermined length that causes no distortion of an RF signal are formed at leading and trailing sides of the group of the two consecutive pits, marks, or spaces of the maximum length. For example, the sync signal may include intervals T₁, T₂, T₃, and T₄ that satisfy a condition T₁≧4T, T₂≧9T, T₃≧9T, and T₄≧4T.

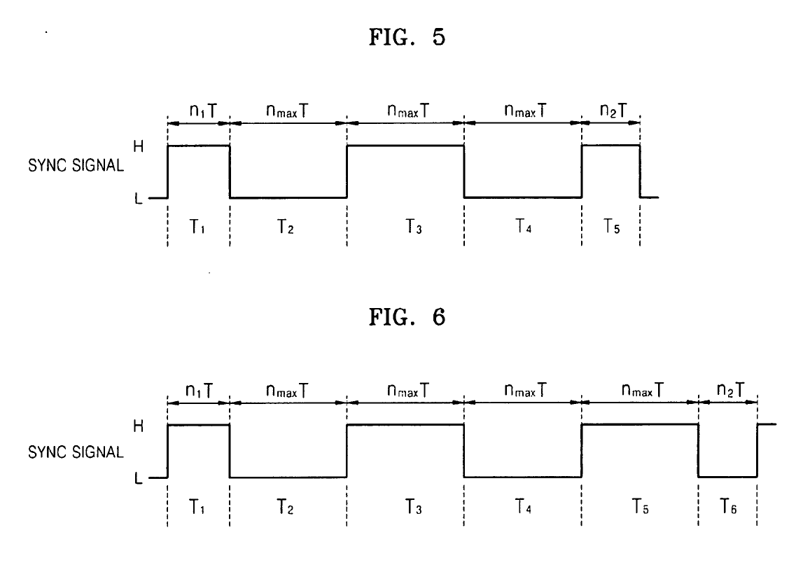

The sync signal illustrated in FIG. 5 is similar to the sync signal illustrated in FIG. 4 except that three pits, marks, or spaces of the maximum length are consecutively connected to one another. The sync signal of FIG. 5 may include intervals T₁, T₂, T₃, T₄, and T₅ that satisfy a condition T₁≧4T, T₂≧9T, T₃≧9T, T₄≧9T, and T₅≧4T.

Similarly, the sync signal of FIG. 6 may be formed in a pattern where four pits, marks, or spaces of the maximum length are consecutively connected to one another. In particular, in the sync signal of FIG. 6, since four maximum inversion intervals are consecutively connected to one another, the sync signal is detectable even when portions of the sync signal corresponding to short intervals, such as n₁T and n₂T, distort adjacent portions of the sync signal corresponding to the maximum inversion intervals. In other words, in FIG. 6, portions of the sync signal corresponding to T₂ and T₅ may be distorted due to portions of the sync signal corresponding to T₁ and T₆, but portions of the sync signal corresponding to T₃ and T₄ may be properly detected. Thus, the sync signal can be properly detected. The sync signal of FIG. 6 may have inversion intervals T₁, T₂, T₃, T₄, T₅, and T₆ that satisfy a condition T₁≧4T, T₂≧9T, T₃≧9T, T₄≧9T, T₅≧9T, and T₆≧4T

Since the sync signals according to the above-described embodiments have the maximum inversion intervals of the sync signal that form a symmetrical pattern, the sync signals are convenient for calculation of a digital sum value.

Although the sync signals having one, two, three, and four maximum inversion intervals, have been described above with reference to FIGS. 3A through 6, respectively, the present invention is not limited to these sync signals, but sync signals having more than four maximum inversion intervals may be equally applied.

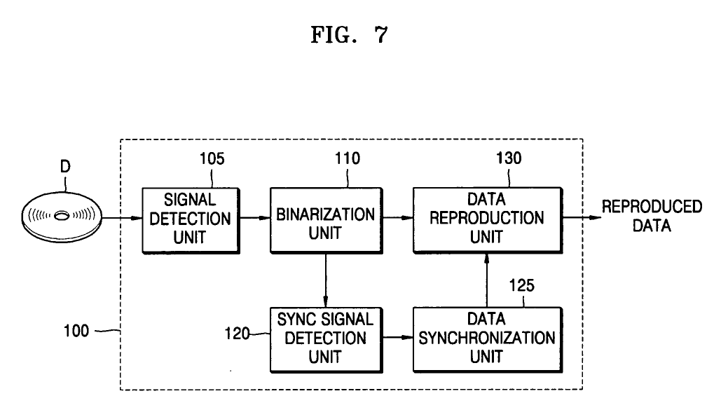

FIG. 7 is a block diagram of an apparatus 100 for reproducing data from an information recording medium D according to an embodiment of the present invention. Referring to FIG. 7, the reproducing apparatus 100 includes a signal detection unit 105, a binarization unit 110, a sync signal detection unit 120, a data synchronization unit 125, and a data reproduction unit 130.

The signal detection unit 105 comprises an optical pickup projecting a reproduction beam onto the information recording medium D, which includes a sync signal having a pattern including one or more maximum inversion intervals as described above, detecting a beam reflected by the information recording medium D, and detecting a signal recorded on the information recording medium D.

The binarization unit 110 converts an analog signal obtained by the signal detection unit 105 into a digital signal.

The sync signal detection unit 120 extracts the sync signal from the digital signal output from the binarization unit 110 and outputs the sync signal to the data synchronization unit 125.

The data synchronization unit 125 produces a reference signal for data reproduction from the sync signal and outputs the reference signal to the data reproduction unit 130. The data reproduction unit 130 reproduces data recorded on the information recording medium D using the digital signal output by the binarization unit 110 and the sync signal that operates as the reference signal output by the data synchronization unit 125.

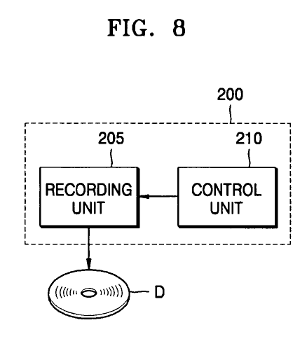

FIG. 8 is a block diagram of an apparatus 200 for recording data to the information recording medium D according to an embodiment of the present invention. Referring to FIG. 8, the recording apparatus 200 includes a recording unit 205 and a control unit 210. The recording unit 205 records data on the information recording medium D under the control of the control unit 210. The control unit 210 controls the recording unit 205 to record the data in units of a predetermined recording block.

In particular, the control unit 210 controls the recording unit 210 to record a sync signal having an inversion interval pattern as described above in every recording block. Accordingly, upon reproduction of the data from the information recording medium D, the sync signal can be properly detected.

As described above, with an increase in the recording capacity of an information recording medium, a sync signal is comprised of inversion intervals equal to or greater than a predetermined length so that an amplitude of an RF signal is equal to or greater than a predetermined level. Thus, reliable detection of the sync signal is possible.

According to the present invention, the sync signal can be stably detected by preventing generation of an error upon detection of the sync signal.

In particular, the sync signal can be stably detected from a high-density information recording medium, such as, a super-resolution information recording medium. Thus, error correction or data demodulation can be stabilized.

Furthermore, the performance of the entire system can be improved by enhancing the reliability of detection of a sync signal that is used as a reference signal upon signal processing in an apparatus associated with information recording media.

Although a few embodiments of the present invention have been shown and described, it would be appreciated by those skilled in the art that changes may be made in this embodiment without departing from the principles and spirit of the invention, the scope of which is defined in the claims and their equivalents.

What is claimed is:

1. An information recording medium, comprising:
a predetermined area having a sync signal recorded thereon to use upon recording and/or reproduction of data, wherein:
the sync signal includes a pattern comprising a first interval having a length equal to or greater than a predetermined length which causes no signal distortion in a reproduction signal and a second interval having a length equal to or greater than a maximum available pit or space length by which reproducible data are recorded on the recording medium, wherein the first interval is adjacent to the second interval and the second interval is inverted with respect to the first interval.

2. The information recording medium of claim 1, wherein the information recording medium is a super-resolution information recording medium capable of reproducing pits, marks, or spaces that are smaller than or equal to a beam resolution limit.

3. The information recording medium of claim 1, wherein each interval is a pit, a mark, or a space that is formed in the predetermined area of the information recording medium.

4. The information recording medium of claim 1, wherein the sync signal is formed to have three intervals using a pit, a mark, or a space, and where lengths of the three intervals are T₁, T₂, and T₃, the interval lengths satisfy a condition where T₁≧n₁T, T₂≧nₘₐₓT, and T₃≧n₂T, where T denotes a period of a reference clock, n₁T and n₂T denote respective lengths which cause no signal distortion, and nₘₐₓT denotes the maximum available length.

5. The information recording medium of claim 1, wherein the sync signal is formed to have four intervals using a pit, a mark, or a space, and where lengths of the four intervals are T₁, T₂, T₃, and T₄, the intervals satisfy a condition where T₁≧n₁T, T₂=T₃=nₘₐₓT, and T₄≧n₂T, where T denotes a period of a reference clock, n₁T and n₂T denote respective lengths which cause no signal distortion, and nₘₐₓT denotes the maximum available length.

6. The information recording medium of claim 1, wherein the sync signal is formed to have five intervals using a pit, a mark, or a space, and where lengths of the four intervals are T₁, T₂, T₃, T₄, and T₅, the intervals satisfy a condition where T₁≧n₁T, T₂=T₃=T₄=nₘₐₓT, and T₅≧n₂T, where T denotes a period of a reference clock, n₁T and n₂T denote respective lengths which cause no signal distortion, and nₘₐₓT denotes the maximum available length.

7. The information recording medium of claim 1, wherein the sync signal is formed to have six intervals using a pit, a mark, or a space, and where lengths of the four intervals are T₁, T₂, T₃, T₄, T₅, and T₆, the intervals satisfy a condition where T₁≧n₁T, T₂=T₃=T₄=T₅=nₘₐₓT, and T₆≧n₂T, where T denotes a period of a reference clock, n₁T and n₂T denote respective lengths which cause no signal distortion, and nₘₐₓT denotes the maximum available length.

8. The information recording medium of claim 4, wherein n, and n₂ are 4, and nₘₐₓ is 9.

9. The information recording medium of claim 5, wherein n, and n₂ are 5, and nₘₐₓ is 9.

10. The information recording medium of claim 6, wherein n₁ and n₂ are 6, and nₘₐₓ is 9.

11. The information recording medium of claim 7, wherein n₁ and n₂ are 7, and nₘₐₓ is 9.

12. An information recording medium, comprising:
a predetermined area having a sync signal recorded thereon to use upon reproduction of data from the recording medium, wherein:
the sync signal includes a pattern comprising first and second intervals having respective lengths equal to or greater than a predetermined length which causes no signal distortion in a reproduction signal and a third interval having a length equal to or greater than a maximum available pit or space length by which reproducible data are recorded on the recording medium, wherein the third interval is disposed between the first and second intervals and each of the intervals is inverted relative to each adjacent interval.

13. The information recording medium of claim 12, wherein:
the respective lengths of the first and second intervals are less than the length of the third interval.

14. The information recording medium of claim 12, wherein the first and second intervals are formed of marks or pits and the third interval is formed of spaces.

15. The information recording medium of claim 12, wherein the first and second intervals are formed of spaces and the third interval is formed of marks or pits.

16. The information recording medium of claim 12, wherein:
the sync signal pattern comprises an even number of the third intervals disposed between the first and second intervals, whereby the second interval is inverted with respect to the first interval.

17. The information recording medium of claim 16, wherein:
the respective lengths of the third intervals are equal, and
the respective lengths of the first and second intervals are less than the length of one of the third intervals.

18. The information recording medium of claim 16, wherein:
the first interval is formed of marks or pits,
the second interval is formed of spaces; and
the third intervals are alternately formed of spaces and marks or pits.

19. The information recording medium of claim 16, wherein:
the first interval is formed of spaces,
the second interval is formed of marks or pits; and
the third intervals are alternately formed of marks or pits and spaces.

20. The information recording medium of claim 1, wherein:
the sync signal pattern further comprises an odd number of the third intervals disposed between the first and second intervals, the odd number being greater than one, wherein the second interval is not inverted with respect to the first interval.

21. The information recording medium of claim 20, wherein:
the respective lengths of the third intervals are equal,
the respective lengths of the first and second intervals are less than the length of one of the third intervals.

22. The information recording medium of claim 20, wherein:
the first and second intervals are formed of marks or pits, and
the third intervals are alternately formed of spaces and marks or pits.

23. The information recording medium of claim 20, wherein:
the first and second intervals are formed of spaces, and
the third intervals are alternately formed of marks or pits and spaces.

24. The information recording medium of claim 12, wherein the pattern of the sync signal is symmetrical.

25. The information recording medium of claim 16, wherein the pattern of the sync signal is symmetrical.

26. The information recording medium of claim 20, wherein the pattern of the sync signal is symmetrical.

27. The information recording medium of claim 12, wherein the sync signal is recorded in each recording block of the recording medium.

28. The information recording medium of claim 16, wherein the sync signal is recorded in each recording block of the recording medium.

29. The information recording medium of claim 20, wherein the sync signal is recorded in each recording block of the recording medium.

30. An apparatus for reproducing data from an information recording medium, the apparatus comprising:
a signal detection unit detecting a signal recorded on the information recording medium;
a binarization unit converting an analog signal obtained by the signal detection unit into a digital signal;
a sync signal detection unit extracting a sync signal from the digital signal output from the binarization unit, wherein the sync signal includes a pattern comprising a first interval having a length equal to or greater than a predetermined length which causes no signal distortion in a reproduction signal and a second interval having a length equal to or greater than a maximum available pit or space length by which reproducible data are recorded on the recording medium, wherein the first interval is adjacent to the second interval and the second interval is inverted with respect to the first interval;
a data synchronization unit producing a reference signal for data reproduction from the sync signal; and
a data reproduction unit reproducing data recorded on the information recording medium using the digital signal output by the binarization unit and the sync signal that operates as the reference signal output by the data synchronization unit.

31. An apparatus for recording data to an information recording medium, the apparatus comprising:
a recording unit recording data on the information recording medium in units of a predetermined recording block; and
a control unit controlling the recording unit to record a sync signal in every recording block, wherein the sync signal includes a pattern comprising a first interval having a length equal to or greater than a predetermined length which causes no signal distortion in a reproduction signal and a second interval having a length equal to or greater than a maximum available pit or space length by which reproducible data are recorded on the recording medium, wherein the first interval is adjacent to the second interval and the second interval is inverted with respect to the first interval.
